(19) United States
(12) Patent Application Publication
(10) Pub. No.: US 2008/0074355 A1
(43) Pub. Date: Mar. 27, 2008

(54) Plasma display panel

(76) Inventor: Tae-Kyoung Kang, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/895,363

(22) Filed: Aug. 24, 2007

(30) Foreign Application Priority Data
Sep. 26, 2006 (KR) 10-2006-0093670

(51) Int. Cl. G09G 3/28

(52) U.S. Cl. 345/67

(57) ABSTRACT

Provided is a plasma display panel that prevents a defect of electrode terminal units. The plasma display panel includes: a front substrate and a rear substrate facing each other; a plurality of barrier ribs disposed to partition a plurality of discharge cells between the front substrate and the rear substrate; a plurality of electrodes disposed between the front substrate and the rear substrate; and a plurality of electrode terminal units electrically connected to the plurality of electrodes, wherein the plurality of electrode terminal units are formed to cover one end of each of the plurality of electrodes.

### CROSS-REFERENCE TO RELATED APPLICATIONS

This application claims the benefit of Korean Patent Application No. 10-2006-0093670, filed on Sep. 26, 2006, in the Korean Intellectual Property Office, the disclosure of which is incorporated herein in its entirety by reference.

### BACKGROUND OF THE INVENTION

1. Field of the Invention

The present embodiments relate to a plasma display panel, and more particularly, to a plasma display panel that prevents a defect of a terminal unit of each electrode.

2. Description of the Related Art

Plasma display devices using plasma display panels are flat display devices that display an image using a gas discharge phenomenon. Plasma display devices are considered to be the next-generation of flat display devices owing to their good display characteristics, such as high brightness, high contrast, low image sticking, wide viewing angles, slim structure, and large screen size.

A conventional plasma display device comprises a plasma display panel including a front substrate and a rear substrate, which face each other, a plurality of electrodes disposed between the front substrate and the rear substrate, and a circuit board for driving the plasma display panel.

In the plasma display panel, discharge electrodes corresponding to display electrodes are disposed on the front glass substrate, and address electrodes are disposed on the rear glass substrate. A sustain discharge is performed between discharge electrode pairs when they are operated. Each electrode is electrically connected to the circuit board via a signal transmission member. Each electrode includes a terminal unit that is electrically connected to the signal transmission member. In this regard, it is difficult to connect a plurality of terminal units to a signal transmission member since the signal transmission member cannot be of a large size. The plurality of terminal units are divided into several groups and each group is connected to one of a plurality of signal transfer units. Each electrode and its terminal unit are integrally formed, which may cause a loss of connection of a terminal of each terminal unit, and a defect in connecting the signal transmission member to each terminal unit.

### SUMMARY OF THE INVENTION

The present embodiments provide a plasma display panel that prevents a defect of a terminal unit of each electrode of the plasma display panel.

According to an aspect of the present embodiments, there is provided a plasma display panel comprising: a front substrate and a rear substrate facing each other; a plurality of barrier ribs disposed to partition a plurality of discharge cells between the front substrate and the rear substrate; a plurality of electrodes disposed between the front substrate and the rear substrate; and a plurality of electrode terminal units electrically connected to the plurality of electrodes, wherein the plurality of electrode terminal units are formed to cover one end of each of the plurality of electrodes.

The thickness of the electrode terminal units may be greater than that of the electrodes.

The thickness of the electrode terminal units may be less than two times the thickness of the electrodes.

The width of the electrode terminal units may be larger than that of the electrodes.

The electrodes may comprise first parts that are covered by the electrode terminal units, and second parts that are not covered by the electrode terminal units, wherein the first parts are tapered so that the thickness of the first parts is reduced towards the electrode terminal units.

The electrodes may comprise first parts that are covered by the electrode terminal units, and second parts that are not covered by the electrode terminal units, wherein the width of the second parts is larger than that of the first parts.

The plasma display panel may further comprise: signal transmission members electrically connected to the electrode terminal units; and phosphor layers disposed in the discharge cells.

According to an aspect of the present embodiments, there is provided a method of manufacturing a plasma display panel, comprising: forming barrier ribs partitioning a plurality of discharge cells on a substrate; forming electrodes corresponding to the discharge cells; and forming electrode terminal units electrically connected to the electrodes, wherein the electrode terminal units are formed to cover one end of each of the electrodes.

The electrode terminal units may be formed using an offset printing method.

### BRIEF DESCRIPTION OF THE DRAWINGS

The above and other features and advantages of the present embodiments will become more apparent by describing in detail exemplary embodiments thereof with reference to the attached drawings in which:

FIG. 1 is a partially exploded perspective view of a plasma display panel according to an embodiment;

FIG. 2 is a plan view of electrodes disposed on edge portions of the plasma display panel according to an embodiment;

FIG. 3 is an enlarged plan view of a part A illustrated in FIG. 2;

FIG. 4 is a cross-sectional view of the part A taken along a line IV-IV of FIG. 3;

FIG. 5 is a cross-sectional view of electrode terminal units of the plasma display panel according to another embodiment; and

FIG. 6 is a plan view of electrode terminal units of the plasma display panel according to another embodiment.

### DETAILED DESCRIPTION OF THE PREFERRED EMBODIMENT

The present embodiments will now be described more fully with reference to the accompanying drawings in which exemplary embodiments are shown.

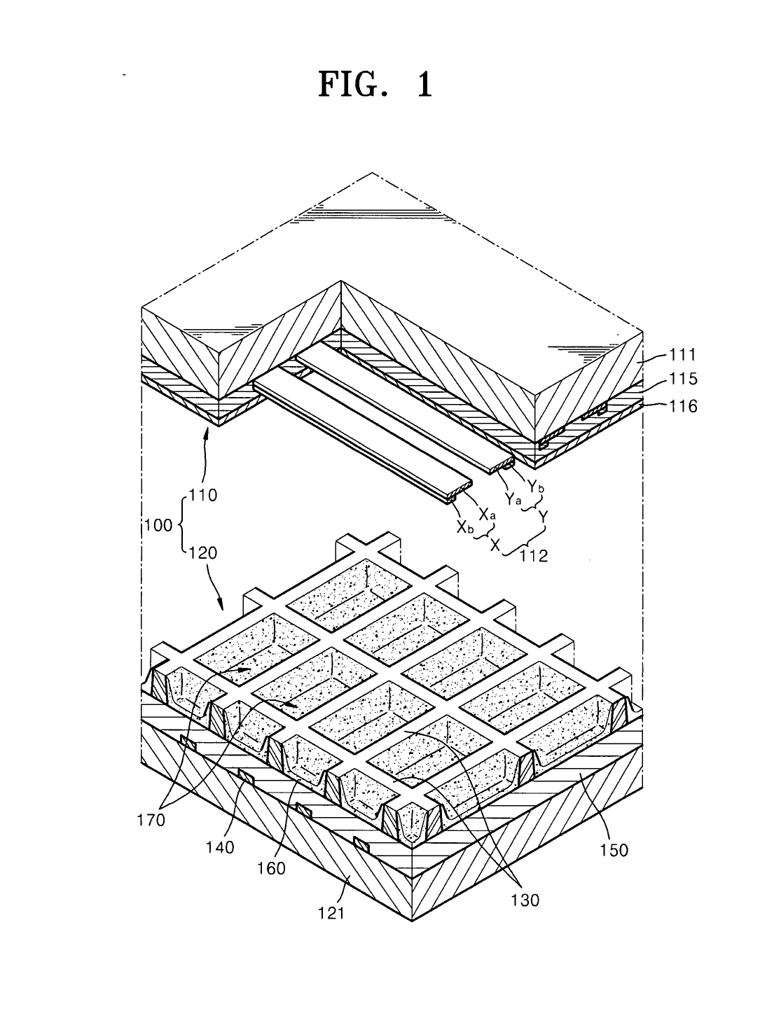

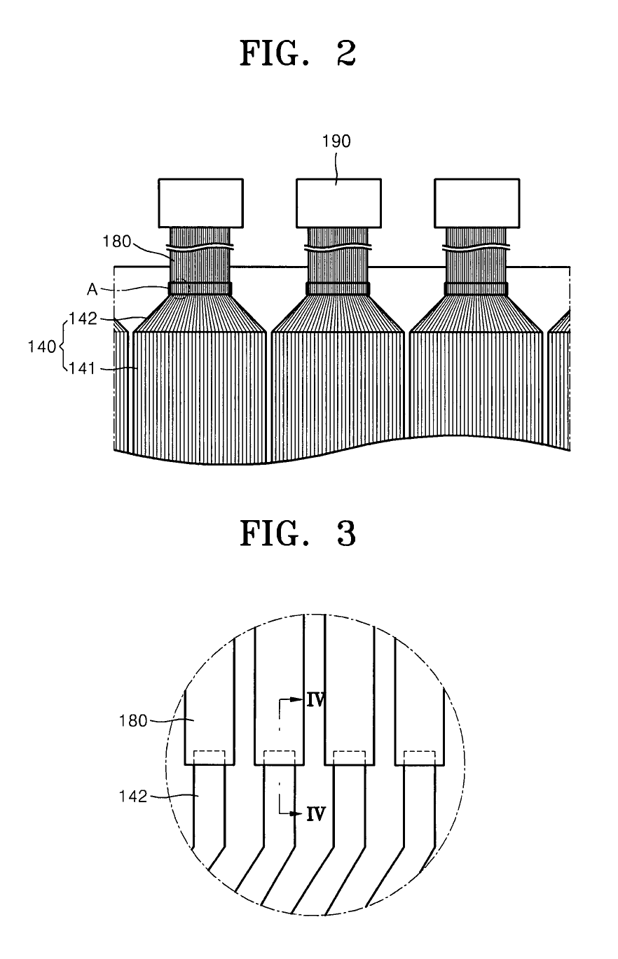

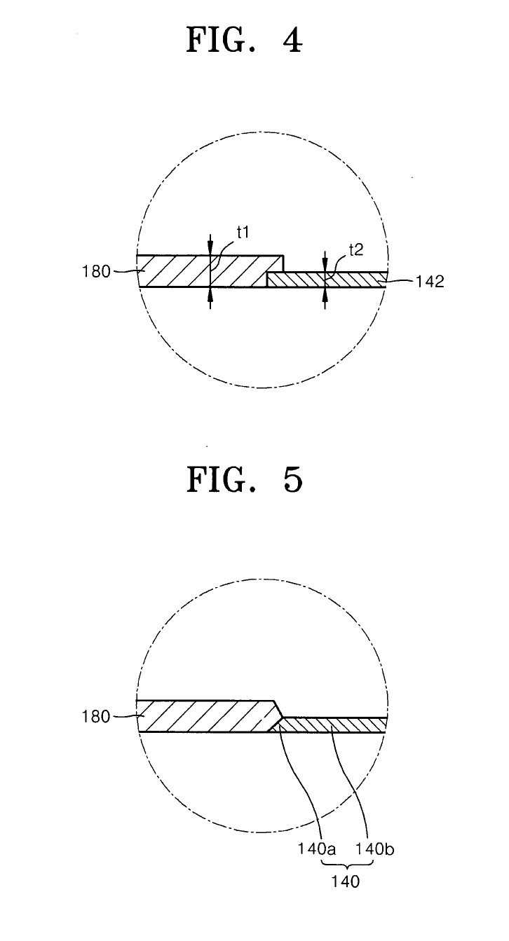

FIG. 1 is a partially exploded perspective view of a plasma display panel 100 according to an embodiment. FIG. 2 is a plan view of electrodes disposed on edge portions of the plasma display panel 100 according to an embodiment. FIG. 3 is an enlarged plan view of a part A illustrated in FIG. 2. FIG. 4 is a cross-sectional view of the part A taken along a line IV-IV of FIG. 3.

Referring to FIGS. 1 and 2, the plasma display panel 100 includes a front panel 110 and a rear panel 120, which face each other. The front panel 110 comprises a front substrate 111, discharge electrodes 112, and a front dielectric layer 115. The rear panel 120 comprises a rear substrate 121, address electrodes 140, a rear dielectric layer 150, barrier ribs 130, and phosphor layers 160. A space between the front panel 110 and the rear panel 120 is filled with a discharge gas.

The front substrate 111 can be formed, for example, of glass having excellent transmittance of visible light. However, the front substrate 111 can be colored in order to increase bright room contrast.

The rear substrate 121 is spaced a predetermined distance apart from the front substrate 111 and faces the front substrate 111. The rear substrate 121 can be formed of glass or colored in order to increase bright room contrast like the front substrate 111. The barrier ribs 130 are disposed between the front substrate 111 and the rear substrate 121.

The barrier ribs 130 partition a discharge space into a plurality of discharge cells 170, and prevent optical and electrical cross-talk between the discharge cells 170. The discharge cells 170, each having a rectangular cross-section, are formed in a matrix. The array of discharge cells 170 comprises a plurality of rows and columns, but the present embodiments are not limited thereto. In detail, the barrier ribs 130 may partition the discharge cells 170 to have polygonal cross-sections, circular cross-sections or oval cross-sections, and the like.

The discharge electrodes 112 are disposed on the front substrate 111. The discharge electrodes 112 comprise X electrodes and Y electrodes, which are spaced apart from each other and are parallel to each other. If a voltage is applied between the X electrodes and the Y electrodes, the X electrodes and the Y electrodes generate a discharge, and include transparent electrodes Xa and Ya and bus electrodes Xb and Yb, respectively. The transparent electrodes Xa and Ya are formed of a transparent and conductive material that can generate the discharge and does not interfere with light emitted from the phosphor layers 160 toward the front substrate 111. The transparent and conductive material can be, for example, indium tin oxide (ITO). However, since the transparent and conductive material such as ITO has a high resistance, if the discharge electrodes X and Y only include the transparent electrodes Xa and Ya formed of ITO, driving power consumption is high and response speed is slow due to a large voltage drop in a length direction of the transparent electrodes Xa and Ya. To address these problems, the bus electrodes Xb and Yb formed of a metal material and having a narrow width are disposed on the transparent electrodes Xa and Ya. The transparent electrodes Xa and Ya and the bus electrodes Xb and Yb can be formed using a photo-etching method, a photolithography method, or the like. The transparent electrodes Xa and Ya can be extended to have a rectangular shape, and can have a variety of arrangements.

The front dielectric layer 115 is formed on the front substrate 111 to cover the discharge electrodes X and Y. The front dielectric layer 115 prevents direct conduction between adjacent discharge electrodes X and Y, and prevents the discharge electrodes X and Y from being damaged due to direct collisions of charged particles or electrons on the discharge electrodes X and Y. Also, the front dielectric layer 115 induces charges to facilitate the generation of wall charges. The front dielectric layer 115 can be formed of a ceramic material having good insulation including, for example, SiO₂, PbO, or Al₂O₃.

A protective layer 116 can be disposed on the front dielectric layer 115 of the front substrate 111. The protective layer 116 prevents the front dielectric layer 115 from being damaged due to direct collisions of positive ions and electrons on the front dielectric layer 115 during the discharge, and increases the amount of secondary electrons emitted in the discharge cells 170. The protective layer 116 can be formed, for example, of a material having MgO which is a ferroelectric substance that can withstand high voltages. The protective layer 116 can be formed as a thin film using sputtering, electronic beam deposition, or the like.

The address electrodes 140 are disposed on the rear substrate 121 facing the front substrate 111 in a predetermined pattern. The address electrodes 140 extend to cross the discharge electrodes X and Y of the front substrate 111 in the discharge cells 170. The address electrodes 140 generate an address discharge that facilitates a sustain discharge between the discharge electrodes X and Y. More specifically, the address electrodes 140 reduce the voltage for generating the sustain discharge.

The discharge electrodes 112 and the address electrodes 140 include discharge units and connection units. The discharge units perform the discharge. The connection units are connected to the discharge units and include ends of the electrodes. The structure of the discharge electrodes 112 and the address electrodes 140 is similar to each other regardless of the type of electrodes. Therefore, the address electrodes 140 will be described in the present embodiment.

As shown on FIG. 2, address electrode terminal units 180 are formed separately from the address electrodes 140 to cover one end of the address electrodes 140. The address electrode terminal units 180 cover ends of connection units 142 of the address electrodes 140. The address electrode terminal units 180 are disposed on the rear substrate 121 and are electrically connected to signal transmission members 190. The address electrodes 140 and the signal transmission member 190 are electrically connected to each other via the address electrode terminal unit 180.

Discharge units 141 of the address electrodes 140 are disposed on an inner surface of the rear substrate 121 to perform an address discharge along with discharge units of the discharge electrodes 112. The discharge units 141 are formed as strips which pass under the center of each of the discharge cells 170, but the present embodiments are not limited thereto. In detail, the discharge units 141 of the present embodiments can be disposed to surround at least a part of each of the discharge cells 170.

The address electrode terminal units 180 are disposed on edges of the rear substrate 121, and are externally exposed to be connected with the signal transmission members 190. According to a single-scan method, scanning is performed in a single direction. Therefore, the address electrode terminal units 180 are formed at one end of the address electrodes 140 and are connected to the signal transmission member 190. According to a double-scan method, the address electrode terminal units 180 are formed at each end of the address electrodes 140 and are connected to the signal transmission member 190. The address electrode terminal units 180 are disposed to cover one end of the connection units 142 of the address electrodes 140 so as to be electrically connected to the address electrodes 140. In the current embodiment, the address electrodes 140 are not integrally formed to include the address electrode terminal units 180 but are formed separately from the address electrode terminal units 180. Therefore, loss of connection of the address electrode terminal units 180 can be prevented. In more detail, when the narrow and long address electrodes 140 are formed to integrally include the address electrode terminal units 180, connection between the address electrode terminal units 180 and the address electrodes 140 may be lost, in particular, where the address electrode terminal units 180, which are part of the narrow and long address electrodes 140, contact the signal transmission members 190. However, in the current embodiment, the address electrodes 140 are initially formed, and the address electrode terminal units 180 are formed to cover one end of the connection units 142 of the address electrodes 140, thereby preventing the loss of connection of the address electrode terminal units 180.

The width of the address electrode terminal units 180 is larger than that of the address electrodes 140. When the address electrodes 140 and the address electrode terminal units 180 are formed separately from each other, if the patterning of the address electrode terminal units 180 is not accurate, reliability of the electrical connection of the address electrode terminal units 180 and the address electrodes 140 can be deteriorated. The width of the address electrode terminal units 180 is broader than that of the address electrodes 140 in order to facilitate the electrical connection of the address electrode terminal units 180 and the address electrodes 140, thereby improving the reliability of the electrical connection between the address electrode terminal units 180 and the address electrodes 140. The larger width of the address electrode terminal units 180 results in an increase in the area where the address electrode terminal units 180 and the signal transmission members 190 electrically connect each other, which improves the reliability of the electrical connection between the address electrode terminal units 180 and the signal transmission members 190. Furthermore, the larger width of the address electrode terminal units 180 increases a sectional area, thereby improving resistance features of the address electrode terminal units 180.

The thickness t1 (see FIG. 4) of the address electrode terminal units 180 is greater than that t2 of the address electrodes 140. Therefore, the reliability of the electrical connection between the address electrode terminal units 180 and the address electrodes 140 and between the address electrode terminal units 180 and the signal transmission members 190 can be improved. The resistance features of the address electrode terminal units 180 and the discharge features can be improved. In one embodiment, the thickness t1 of the address electrode terminal units 180 can be less than two times the thickness t2 of the address electrodes 140. In this embodiment, the relationship between t1 and t2 can be represented by: t1<2×t2.

FIG. 5 is a cross-sectional view of electrode terminal units of the plasma display panel 100 according to another embodiment that shows further improvements. Referring to FIG. 5, the thickness of the address electrodes 140 is reduced towards one end where the address electrodes 140 and the address electrode terminal units 180 are electrically connected to have a taper shape. The address electrodes 140 include first parts 140a that are covered by the address electrode terminal units 180 and second parts 140b that are not covered by the address electrode terminal units 180. The thickness of the first parts 140a is reduced towards the address electrode terminal units 180 to have the taper shape. When the first parts 140a of the address electrodes 140 are tapered to be connected to the address electrode terminal units 180, the address electrode terminal units 180 can easily cover one end of the address electrodes 140. Therefore, the reliability of the electrical connection between the address electrode terminal units 180 and the address electrodes 140 can be improved. If the address electrode terminal units 180 are thicker than the address electrodes 140, the address electrodes 140 are transformed due to the loads of the address electrode terminal units 180 so that the first parts 140a of the address electrodes 140 can be naturally tapered. In this regard, the ends of the address electrode terminal units 180 can be slightly inclined.

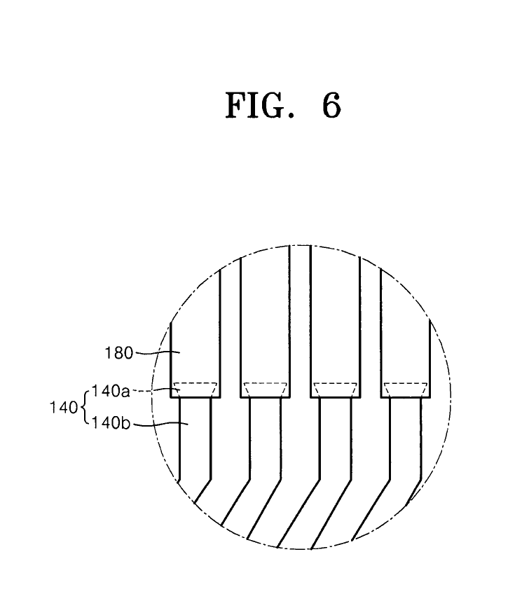

FIG. 6 is a plan view of electrode terminal units of the plasma display panel 100 according to another embodiment. Referring to FIG. 6, the address electrodes 140 include first parts 140a that are covered by the address electrode terminal units 180 and second parts 140b that are not covered by the address electrode terminal units 180. The address electrodes 140 can be formed so that the first parts 140a are wider than the second parts 140b. Therefore, the reliability of the electrical connection of the address electrode terminal units 180 and the address electrodes 140 can be improved. If the address electrode terminal units 180 are thicker than the address electrodes 140, the address electrodes 140 are transformed due to the loads of the address electrode terminal units 180 so that the first parts 140a are wider than the second parts 140b. The first parts 140a are formed in a trapezoid shape but the present embodiments are not limited thereto. In detail, the first parts 140a can have a variety of shapes including a rectangular shape, etc., so that the first parts 140a are wider than the second parts 140b.

The address electrodes 140 can be formed using various methods including a screen-printing method, a photolithography method, a lift-off method, or the like.

The address electrode terminal units 180 can be formed using an offset printing method after the address electrodes 140 are formed. The offset printing method can be used to easily adjust the width and thickness of the address electrode terminal units 180. The offset printing method does not require a firing process unlike the screen printing method so that it is easy to form the desired shape of the address electrode terminal units 180. However, other various methods can be used to form the address electrode terminal units 180.

The signal transmission members 190 are electrically connected to a driving circuit board (not shown) for driving the plasma display panel 100. A flexible printed cable (FPC) or a tape carrier package (TCP) can be used as the signal transmission members 190. The signal transmission members 190 include wires transferring an electrical signal. Each wire is electrically connected to the address electrode terminal units 180. The wires of the signal transmission members 190 and the address electrode terminal units 180 are connected to each other via an anisotropic conductive film.

The rear dielectric layer 150 is formed on the rear substrate 121 to cover the address electrodes 140. The rear dielectric layer 150 prevents the address electrodes 140 from being damaged due to collisions of charge particles or electrons on the address electrodes 140 and induces charges. The rear dielectric layer 150 can be formed of, for example, PbO, B₂O₃, SiO₂, or the like.

The phosphor layers 160 are disposed on the rear dielectric layer 150. The phosphor layers 160 can be formed of red, green, and blue light-emitting phosphors. The phosphor layers 160 emit visible light when ultraviolet rays are incident thereon. That is, a phosphor layer formed in a red light-emitting discharge cell includes a phosphor such as Y(V,P)O₄:Eu, a phosphor layer formed in a green light-emitting discharge cell includes a phosphor such as Zn₂SiO₄:Mn, YBO₃:Tb, and a phosphor layer formed in a blue light-emitting discharge cell includes a phosphor such as BAM:Eu.

The discharge cells 170 are filled with a discharge gas in which Ne gas and Xe gas are mixed. When the discharge cells 170 are filled with the discharge gas, the front substrate 111 and the rear substrate 121 are coupled to each other using a sealing member such as frit glass formed on edges of the front and rear substrates 111 and 121.

The operation of the plasma display panel 100 having the above structure according to the present embodiments will be described.

An address voltage is applied between the address electrodes 140 and the Y electrodes so that an address discharge is generated. The address discharge results in the selection of the discharge cells 170 where a sustain discharge is to be generated.

The sustain discharge excites the discharge gas into high energy levels and transitions from the high energy levels to low energy levels occurs, thereby emitting ultraviolet rays. The ultraviolet rays excite the phosphor layers 160 coated in the discharge cells 170, such that transitions from high energy levels to low energy levels of the excited phosphor layers 160 occurs to emit visible rays which are transmitted out of the plasma display panel 100 and can be used to form an image which is recognizable by a user. The address electrode terminal units 180 and the address electrodes 140 are formed separately from each other. The address electrode terminal units 180 are formed to cover one end of the address electrodes 140 in order to improve the reliability of the electrical connection of the address electrodes 140 and the address electrode terminal units 180. The width and thickness of the address electrode terminal units 180 are larger than those of the address electrodes 140 so that the reliability of the electrical connection between the address electrode terminal units 180 and the address electrodes 140 and between the address electrode terminal units 180 and the signal transmission members 190 can be improved, and the resistance features of the address electrode terminal units 180 can be improved.

The plasma display panel of the present embodiments can delay or prevent a defect of electrode terminal units.

While the present embodiments have been particularly shown and described with reference to exemplary embodiments thereof, it will be understood by those of ordinary skill in the art that various changes in form and details may be made therein without departing from the spirit and scope of the present embodiments as defined by the following claims.

What is claimed is:

1. A plasma display panel comprising:
a front substrate and a rear substrate facing each other;
a plurality of barrier ribs disposed to partition a plurality of discharge cells between the front substrate and the rear substrate;
a plurality of electrodes disposed between the front substrate and the rear substrate; and
a plurality of electrode terminal units electrically connected to the plurality of electrodes,
wherein the plurality of electrode terminal units are configured to cover one end of each of the plurality of electrodes.

2. The plasma display panel of claim 1, wherein the thickness of the electrode terminal units is greater than that of the electrodes.

3. The plasma display panel of claim 2, wherein the thickness of the electrode terminal units is less than double the thickness of the electrodes.

4. The plasma display panel of claim 1, wherein the width of the electrode terminal units is larger than that of the electrodes.

5. The plasma display panel of claim 1, wherein the electrodes comprise first parts that are covered by the electrode terminal units, and second parts that are not covered by the electrode terminal units,
wherein the first parts are tapered so that the thickness of the first parts is reduced towards the electrode terminal units.

6. The plasma display panel of claim 1, wherein the electrodes comprise first parts that are covered by the electrode terminal units, and second parts that are not covered by the electrode terminal units,
wherein the width of the second parts is larger than that of the first parts.

7. The plasma display panel of claim 1, wherein the electrode terminal units are formed using an offset printing method.

8. The plasma display panel of claim 1, further comprising:
signal transmission members electrically connected to the electrode terminal units; and
phosphor layers disposed in the discharge cells.

9. A method of manufacturing a plasma display panel, comprising:
forming barrier ribs partitioning a plurality of discharge cells on a substrate;
forming electrodes corresponding to the discharge cells; and
forming electrode terminal units electrically connected to the electrodes,
wherein the electrode terminal units are configured to cover one end of each of the electrodes.

10. The method of claim 9, wherein the electrode terminal units are formed using an offset printing method.

11. The method of claim 9, wherein the thickness of the electrode terminal units is greater than that of the electrodes.

12. The method of claim 9, wherein the thickness of the electrode terminal units is less than double the thickness of the electrodes.

13. The method of claim 9, wherein the width of the electrode terminal units is larger than that of the electrodes.

14. The method of claim 9, wherein the electrodes comprise first parts that are covered by the electrode terminal units, and second parts that are not covered by the electrode terminal units,
wherein the first parts are tapered so that the thickness of the first parts is reduced towards the electrode terminal units.

15. The method of claim 9, wherein the electrodes comprise first parts that are covered by the electrode terminal units, and second parts that are not covered by the electrode terminal units,
wherein the width of the second parts is larger than that of the first parts.
